(19) United States
(12) Patent Application Publication
(10) Pub. No.: US 2026/0308834 A1
(43) Pub. Date: Oct. 8, 2026

(54) SELF-CLEANING SYSTEM FOR A HEAT PUMP DRYER

(71) Applicant: Whirlpool Corporation, Benton Harbor, MI (US)

(72) Inventors: Rahul CHHAJED, St. Joseph, MI (US); Victor VARGAS, Stevensville, MI (US); Wesley Paul TRAYLOR, St. Joseph, MI (US); Norbert KASZYCKI, St. Joseph, MI (US); Marlene CARVAJAL, Guadalupe (MX)

(73) Assignee: Whirlpool Corporation, Benton Harbor, MI (US)

(21) Appl. No.: 19/098,661

(22) Filed: Apr. 2, 2025

(51) Int. Cl. D06F 58/45; B08B 3/02; B08B 13/00; D06F 34/18; D06F 58/02; D06F 58/20; D06F 58/22; D06F 58/24; D06F 103/08; D06F 105/02; D06F 105/54; F25B 47/00

(52) U.S. Cl. CPC D06F 58/45; B08B 3/02; B08B 13/00; D06F 34/18; D06F 58/02; D06F 58/206; D06F 58/22; D06F 58/24; F25B 47/00; D06F 2103/08; D06F 2105/02; D06F 2105/54; F25B 2347/00

(57) ABSTRACT

A laundry appliance including a cabinet. A drum is rotatably supported in the cabinet. A blower fan is arranged in the cabinet. A basement is arranged in the cabinet. The basement includes a first basement opening, a second basement opening, and a basement cavity defined between the first basement opening and the second basement opening. A connector channel connects the first basement opening in fluid communication with the drum. An airflow channel connects the blower fan in fluid communication with the second basement opening. A heat exchanger system is arranged in the basement cavity and is arranged in fluid communication with the airflow channel. A self-cleaning system includes a nozzle directed at the second basement opening. The self-cleaning system selectively directs a jet of fluid onto basement surfaces to remove detritus.

### FIELD

The present disclosure relates to the art of laundry appliances and, more particularly, to a heat pump dryer including a self-cleaning system.

### BACKGROUND

This section provides background information related to the present disclosure which is not necessarily prior art.

Laundry appliances are prolific in both residential and commercial settings. Laundry appliances may include dryers that are used to dry laundry after it has been cleaned in a washing machine. Laundry appliances also include washer and dryer combination appliances where a single machine performs both the washing and drying functions. There are a few different names used to describe washer and dryer combination appliances, including without limitation, “washer/dryer combos” and “all-in-one washer dryers.”

Many laundry appliances include a cabinet (i.e., an appliance housing) with an opening that is accessed by an appliance door. A drum is positioned in the cabinet and is rotatable with respect to the cabinet. The drum typically has a drum opening that provides access to a laundry compartment inside the drum. These laundry appliances also include a blower that directs airflow into the drum, and a heat exchanger system that heats the airflow. The heat exchanger system may take on a variety of forms including electric resistive elements, heat exchangers including an evaporator and a condenser, or other systems that may heat a moving airflow.

As the airflow leaves the drum it may carry lint and/or other debris transferred from articles of laundry. Most of the lint and other debris is captured by a primary lint filter arranged in an outlet duct accessible from the opening at the drum. The primary lint filter does not capture all of the lint entrained in the airflow exiting the drum. As such, some lint may find its way into the heat exchanger system and come to rest on heat exchanger surfaces or may be trapped in a secondary filter arranged at an inlet to the heat exchanger system. Lint covering heat exchanger surfaces or trapped in a filter at an inlet to the heat exchanger system may reduce an overall operational efficacy of the laundry appliance.

### SUMMARY

This section provides a general summary of the disclosure and is not a comprehensive disclosure of its full scope or all of its features.

A laundry appliance, in accordance with the present disclosure, includes a cabinet. A drum is rotatably supported in the cabinet. A blower fan is arranged in the cabinet. A basement is arranged in the cabinet. The basement includes a first basement opening, a second basement opening, and a basement cavity defined between the first basement opening and the second basement opening. A connector channel connects the first basement opening in fluid communication with the drum. An airflow channel connects the blower fan in fluid communication with the second basement opening of the basement. A heat exchanger system is arranged in the basement cavity and is arranged in fluid communication with the airflow channel. A self-cleaning system includes a nozzle directed at the second basement opening. The self-cleaning system selectively directs a jet of fluid onto basement surfaces to remove detritus.

A method of cleaning a laundry appliance, in accordance with the present disclosure, includes loading articles to be dried into a drum, activating a drum motor to rotate the drum, directing a flow of air into the drum to dry the articles, supplying an amount of fluid to a nozzle directed at a basement and/or a heat exchanger system of the laundry appliance, and spraying the fluid from the nozzle towards the heat exchanger system and/or the basement.

The present disclosure describes system for initiating a self-clean of internal surfaces of a heat pump dryer. By cleaning the internal surfaces without the need to disassemble the laundry appliance, airflow through the heat exchanger system may be maximized and heat exchange efficiencies increased. The self-cleaning system could be supplied with fluid from a main water supply or from a condensate holding tank.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations and are not intended to limit the scope of the present disclosure.

FIG. 1 is a front perspective view of a laundry appliance including a self-cleaning system, in accordance with the present disclosure;

FIG. 2 is a rear perspective view of the exemplary laundry appliance shown in FIG. 1, in accordance with the present disclosure;

FIG. 3 is a partial cross-sectional side view of the exemplary laundry appliance shown in FIG. 1, in accordance with the present disclosure;

FIG. 4 is a perspective view of the basement arranged in the laundry appliance of FIG. 1 including the self-cleaning system, in accordance with the present disclosure;

FIG. 5 is a top view of the basement of FIG. 4, in accordance with an aspect of the present disclosure;

FIG. 6 is a top view of a filter cleaning nozzle of the self-cleaning system, in accordance with the present disclosure;

FIG. 7 is a bottom view of the filter cleaning nozzle of FIG. 6, in accordance with another aspect of the present disclosure;

FIG. 8 is a perspective view of a filter cleaning nozzle of the self-cleaning system, in accordance with the present disclosure;

FIG. 9 is a cross-sectional side view of a basement of the laundry appliance of FIG. 1 including a heat pump cleaning nozzle, in accordance with the present disclosure;

FIG. 10 is a partial perspective view of the basement of FIG. 9 illustrating the heat pump cleaning nozzle mounted to a basement cover, in accordance with the present disclosure;

FIG. 11 is a block diagram illustrating a control system for the self-cleaning system, in accordance with the present disclosure; and

FIG. 12 depicts a flow chart illustrating a method of operating a self-cleaning system, in accordance with the present disclosure.

Corresponding reference numerals indicate corresponding parts throughout the several views of the drawings.

### DETAILED DESCRIPTION

Example embodiments will now be described more fully with reference to the accompanying drawings.

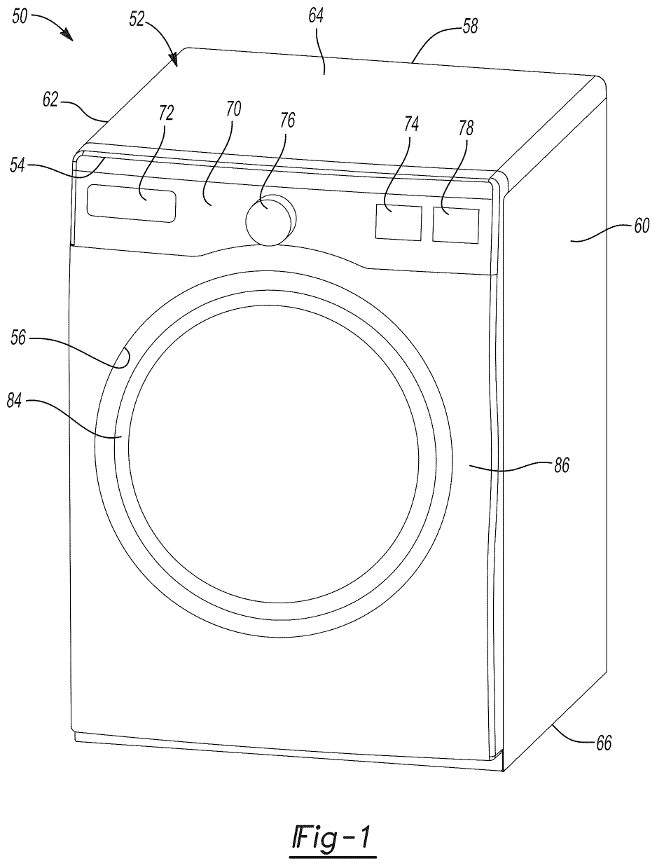

With reference to FIGS. 1-3, a laundry appliance 50 is illustrated. The laundry appliance 50 is a dryer and more specifically, a heat pump dryer machine in the illustrated example. The laundry appliance 50 is illustrated as having a front-load configuration, though may alternatively have a top-load configuration. While shown and described as being a dryer, laundry appliance 50 may also take the form of a combination washer/dryer.

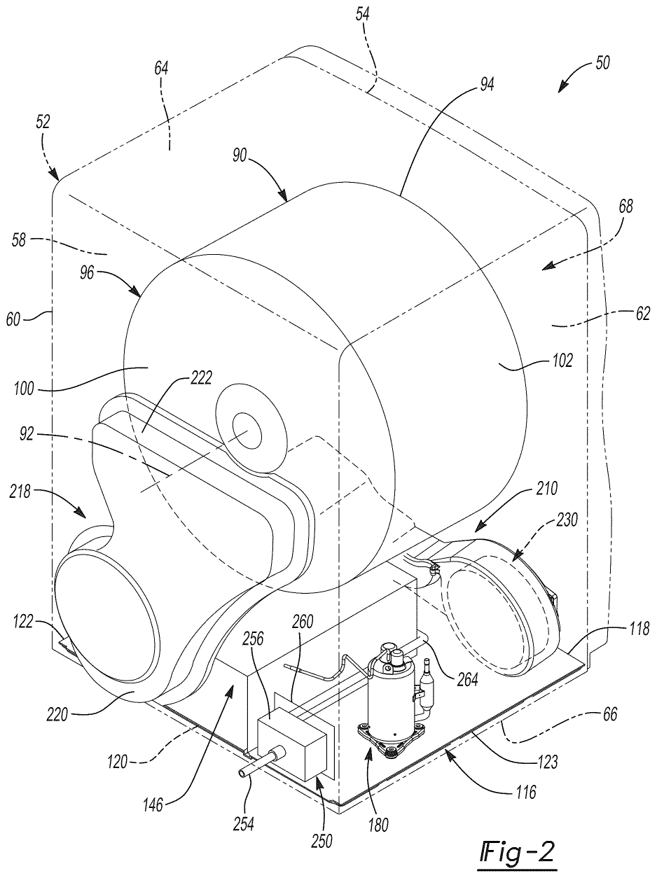

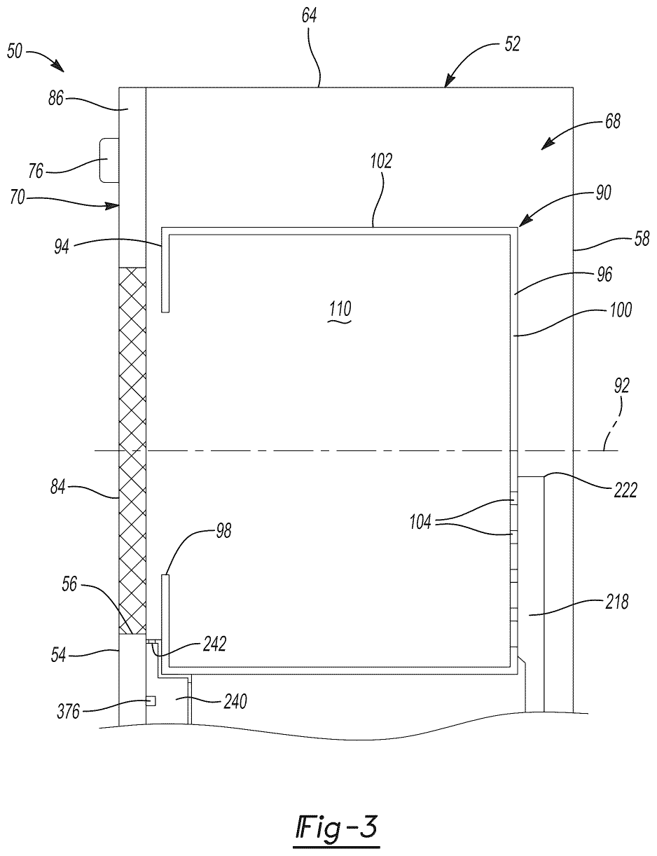

The laundry appliance 50 includes a cabinet 52 that is rectangular in shape. The cabinet 52 includes a front cabinet wall 54 having a front cabinet opening 56, a rear cabinet wall 58 opposite the front cabinet wall 54, a right cabinet sidewall 60 (FIG. 2), and a left cabinet sidewall 62. Right cabinet sidewall 60 and left cabinet sidewall 62 extend between the front cabinet wall 54 and the rear cabinet wall 58. Cabinet 52 is further shown to include a top cabinet wall 64, and a bottom cabinet wall 66. The front cabinet wall 54, rear cabinet wall 58, right cabinet sidewall 60 and left cabinet sidewall 62, top cabinet wall 64, and bottom cabinet wall 66 cooperate to define a cabinet cavity 68 (FIG. 3) inside the cabinet 52.

In some configurations, the laundry appliance 50 may include a control panel 70 that is attached to the front cabinet wall 54. The control panel 70 may be positioned adjacent to the top cabinet wall 64. The control panel 70 may include a display 72, a speaker 74, a control selector 76, and a control module 78. The display 72 may be used to display information, adjust features or settings of the laundry appliance 50, present prompts to users of the laundry appliance 50, and to perform one or more other functions. The display 72 may be a touch screen display. The speaker 74 may be used to output audible sounds and to perform one or more other functions. The control selector 76 may be used to adjust features or settings of the laundry appliance 50 and to perform one or more other functions.

The control module 78 may receive input from the user (e.g., via the display 72 or the control selector 76). The control module 78 may be configured to operate a cycle (e.g., a drying cycle) of the laundry appliance 50 according to the user's input and may perform one or more other functions as will be detailed more fully herein. Additional functions of the control module 78 will be described below. It should be appreciated that display 72, speaker 74, control selector 76, and control module 78 may be positioned in another suitable location on the laundry appliance 50.

A front appliance door 84 is pivotally connected to the cabinet 52, and more specifically, to the front cabinet wall 54 of the cabinet 52. The front appliance door 84 swings between an open door position and a closed door position. In the open door position, the front appliance door 84 provides access to the front cabinet opening 56. In the closed door position, the front appliance door 84 shuts or closes the front cabinet opening 56. When in the closed door position, the front appliance door 84 may be flush with or positioned adjacent to a front facia 86 of the cabinet 52. Although other materials can be used, in the illustrated example, the front appliance door 84 is composed of metal.

The laundry appliance 50 includes a drum 90 that is positioned in the cabinet cavity 68 and is rotatable with respect to the cabinet 52 about a drum axis 92. The drum 90 has a cylindrical shape and extends between a front drum end 94 and a rear drum end 96. The drum 90 includes a front drum opening 98 at the front drum end 94, a rear drum wall 100 at the rear drum end 96, and a drum sidewall 102 that extends between the front drum end 94 and rear drum end 96. One or more drum inlets 104 extend through the rear drum wall 100.

The front drum end 94, the drum sidewall 102, and the rear drum wall 100 cooperate to define a laundry compartment 110 inside the drum 90. The front cabinet opening 56 in the front cabinet wall 54 and the front drum opening 98 at the front drum end 94 are at least partially aligned with one another and therefore provide access to the laundry compartment 110 inside the drum 90 when the front appliance door 84 is in the open door position. In the illustrated example, the front cabinet opening 56 in the front cabinet wall 54 and the front drum opening 98 at the front drum end 94 are aligned with the drum axis 92. It should be appreciated that in use, laundry (e.g., clothes, towels, and/or bedding, etc.) is placed inside the laundry compartment 110 where it is dried during the drying cycle of the laundry appliance 50.

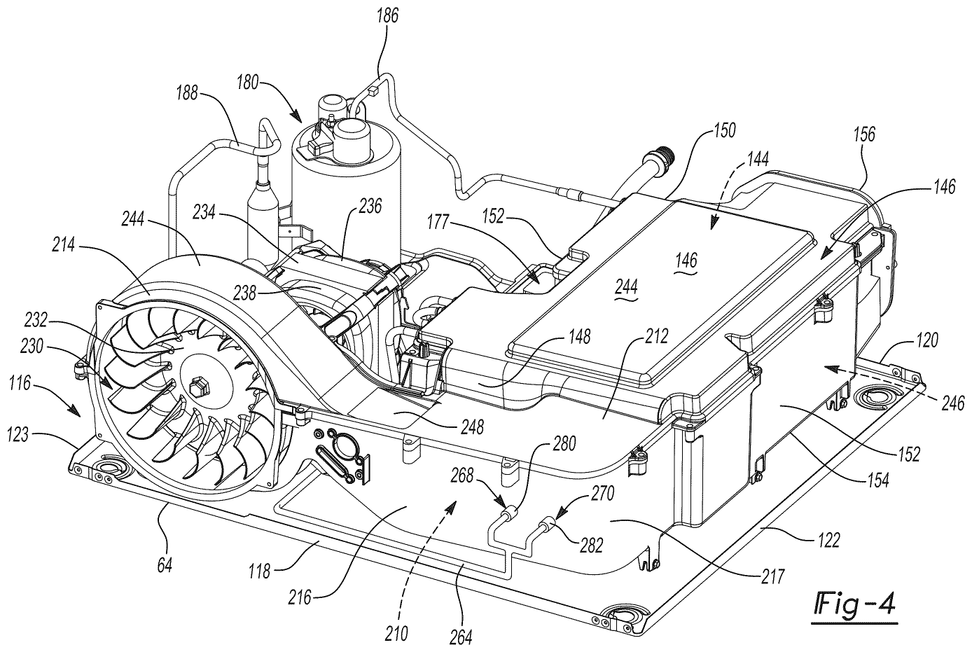

Referring to FIG. 4 and with continued reference to FIGS. 1-3, the laundry appliance 50 includes an appliance base 116 disposed between the drum 90 and the bottom cabinet wall 66. The appliance base 116 is attached to the bottom cabinet wall 66. The appliance base 116 extends between a front base end 118 and a rear base end 120 that is opposite the front base end 118. The front base end 118 is positioned adjacent to and attached to the front cabinet wall 54. The rear base end 120 is positioned adjacent to and attached to the rear cabinet wall 58. The appliance base 116 extends laterally between a first base side 122 and a second base side 123 opposite the first base side 122. The first base side 122 is positioned adjacent to the right cabinet sidewall 60 and the second base side 123 is positioned adjacent to the left cabinet sidewall 62.

The laundry appliance 50 includes a heat exchanger system 144 disposed within a basement 146 of the appliance base 116. The heat exchanger system 144 is configured to heat air flowing through basement 146 towards laundry compartment 110. The basement 146 is positioned adjacent to the first base side 122 and between the front base end 118 and rear base end 120 of the appliance base 116. The basement 146 includes a front basement wall 148, a rear basement wall 150, basement sidewalls 152 extending between the front basement wall 148 and rear basement wall 150, and a bottom basement wall 154. When laundry appliance 50 takes the form of a washer/dryer combination appliance, the basement can be mounted above the drum and thus define an attic. Thus, the term basement should be understood to encompass a housing mounted on appliance base 116 or in an upper portion of a combination washer/dryer appliance.

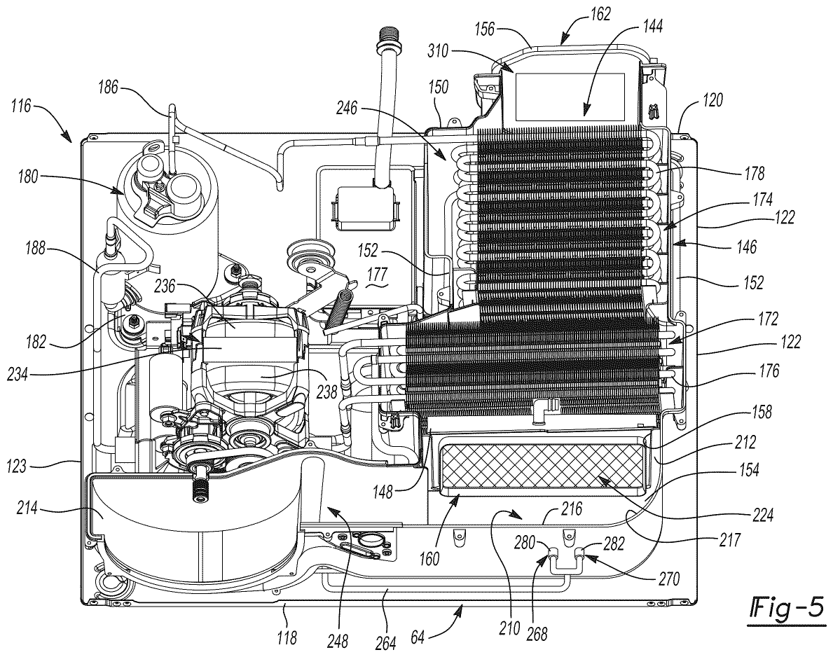

The front basement wall 148 is positioned adjacent to the front base end 118 of the appliance base 116. The rear basement wall 150 is positioned adjacent to the rear base end 120 of the appliance base 116. The basement 146 is arranged in fluid communication with laundry compartment 110 via a first basement opening 156 in the rear basement wall 150. The basement 146 includes a second basement opening 158 (FIG. 5) in the front basement wall 148. Second basement opening 158 defines a basement inlet 160, and first basement opening 156 defines a basement outlet 162. The bottom basement wall 154 may be inclined such that the bottom basement wall 154 in a position adjacent to the rear basement wall 150 is positioned lower (e.g., closer to the bottom cabinet wall 66) than the bottom basement wall 154 in a position adjacent to the front basement wall 148. In other words, the bottom basement wall 154 in a position adjacent to the front basement wall 148, is positioned higher (e.g., closer to the top cabinet wall 64) than the bottom basement wall 154 in a position adjacent to the rear basement wall 150.

Referring to FIG. 5, the heat exchanger system 144 includes a first heat exchanger 172 and a second heat exchanger 174. In accordance with the present disclosure, first heat exchanger 172 is an evaporator (not separately labeled) and second heat exchanger 174 is a condenser (also not separately labeled). In accordance with one exemplary aspect, the first heat exchanger 172 and second heat exchanger 174 are positioned adjacent to each other. More specifically, the first heat exchanger 172 is positioned adjacent to the front cabinet wall 54, and more specifically, the front basement wall 148. The second heat exchanger 174 is positioned adjacent to the rear cabinet wall 58, and more specifically, the rear basement wall 150. In some examples, the first heat exchanger 172 and second heat exchanger 174 may abut each other.

The first heat exchanger 172 is configured to condense air flowing into basement 146 through basement inlet 160. The air is condensed before the air reaches the second heat exchanger 174. The first heat exchanger 172 includes a first pipe 176 extending through the first heat exchanger 172. The first pipe 176 is configured to carry refrigerant or another suitable fluid to aid in condensing the air. Fluid (e.g., water vapor) may be released from the first heat exchanger 172 when the first heat exchanger 172 condenses air passing through the first heat exchanger 172. More specifically, when air is condensed using the first heat exchanger 172, moisture is removed from the air and fluid falls under gravity towards the bottom basement wall 154. The condensate is collected and delivered to a condensate holding tank 177 where it may evaporate, be withdrawn, or be used in other systems as will become more fully evident herein.

The second heat exchanger 174 is configured to heat the air flowing from the first heat exchanger 172 and out of the basement 146 of the appliance base 116. The second heat exchanger 174 includes a second pipe 178 extending through the second heat exchanger 174. The second pipe 178 is configured to carry refrigerant or another suitable fluid. Accordingly, air flows through the heat exchanger system 144 to first be condensed by the first heat exchanger 172 and subsequently heated by the second heat exchanger 174 to create heated air that is passed into drum 90 via first basement opening 156.

The first pipe 176 and second pipe 178 of the first heat exchanger 172 and second heat exchanger 174 of the heat exchanger system 144 are configured to receive refrigerant or another suitable fluid from a compressor 180. The compressor 180 is attached to a compressor base 182 and to the appliance base 116. The compressor base 182 is positioned adjacent to the rear base end 120 and the second base side 123. Compressor 180 includes a refrigerant outlet 186 that is connected in fluid communication with the second pipe 178 and a refrigerant inlet 188 that is connected in fluid communication to first pipe 176.

Compressor 180 pressurizes the refrigerant flowing through heat exchanger system 144. In accordance with the present disclosure, the refrigerant is hydrocarbon based. When compressed, the temperature of the refrigerant increases. The increase in temperature is passed into the airflow passing through heat exchanger system 144. At this point, it should be understood that the type of refrigerant used in heat exchanger system 144 may vary and could include refrigerants other than hydrocarbon refrigerants.

The appliance base 116 includes an airflow channel 210 disposed adjacent to the basement 146. The airflow channel 210 extends between a first channel end 212 and a second channel end 214 that is opposite the first channel end 212. A sidewall 216 extends between and connects the first channel end 212 with the second channel end 214 through a bend portion 217. The first channel end 212 is arranged in fluid communication with the basement 146 via the second basement opening 158. The second channel end 214 is positioned at the front base end 118 the appliance base 116 and adjacent to the second base side 123 of the appliance base 116. More specifically, second channel end 214 is configured to receive ambient air that is directed into basement 146. As shown in FIG. 2, basement 146 is arranged in fluid communication with drum 90 via a connector channel 218. More specifically, first basement opening 156 is connected in fluid communication with connector channel 218 which, in turn, is connected in fluid communication with drum 90 as will be explained herein.

The connector channel 218 extends between a first connector channel end 220 and a second connector channel end 222 that is opposite the first connector channel end 220. The first connector channel end 220 is arranged in fluid communication with first basement opening 156. The second connector channel end 222 is arranged in fluid communication with the laundry compartment 110 of the drum 90 via one or more drum inlets 104 (shown in FIG. 3).

In a non-limiting example, a filter 224 is positioned across second basement opening 158 and is configured to capture and prevent particulate that may be entrained in the air passing through airflow channel 210 from entering heat exchanger system 144.

A blower 230 (FIG. 4) is configured to blow air through the airflow channel 210, through basement 146 across first heat exchanger 172 and second heat exchanger 174, and into drum 90. The blower 230 includes a squirrel cage or blower fan 232 arranged at second channel end 214 of airflow channel 210. Blower fan 232 is operatively connected to a motor 234 that is positioned in the appliance base 116. The motor 234 is positioned adjacent to the front base end 118 and the second base side 123 of the appliance base 116. The motor 234 is positioned between the airflow channel 210 and the compressor base 182.

In accordance with an exemplary aspect, motor 234 may be a variable speed motor that is operatively connected to control module 78. In accordance with another exemplary aspect, motor 234 may take the form of a variable speed dual rotor motor having a drum motor portion 236 operatively connected to drum 90 and a blower motor portion 238 operatively connected to blower fan 232. Blower fan 232 may be connected in fluid communication with an ambient air inlet (not shown) in the case of an open loop system or may be connected to a return duct 240 (FIG. 3) arranged along front cabinet wall 54 in the case of a closed loop system. Return duct 240 includes a duct opening 242 that is connected in fluid communication with front drum opening 98. A lint trap, (not shown), may be arranged at duct opening 242.

A base cover 244 is sealingly engaged with (i.e., seals against) the appliance base 116 and is disposed on top of the appliance base 116. More specifically, the base cover 244 extends over and encloses the basement 146 and the airflow channel 210. The base cover 244 and the basement 146 cooperate to define a basement cavity 246. Blower 230 includes an outlet 248 that directs air through airflow channel 210 into basement cavity 246. The air passes in heat exchange relationship with first heat exchanger 172 and second heat exchanger 174. First heat exchanger 172 removes moisture from the air and second heat exchanger 174 increases a temperature of the air. The air is then directed back into laundry compartment 110.

Laundry appliance 50 includes a self-cleaning system 250 that directs one or more streams or jets of fluid onto surfaces of basement 146 including filter 224 and/or into basement cavity 246 at first heat exchanger 172 and/or second heat exchanger 174. In accordance with an aspect of the present disclosure, the fluid takes the form of water that enters laundry appliance 50 through a fluid inlet 254 (FIG. 2) that may be connected to a main water supply (not shown) of a house or building. Fluid inlet 254 is controlled by a valve 256 and is connected in fluid communication with a pump 260 which, in turn, is connected to a conduit 264. Pump 260 is also operatively connected to control module 78. Conduit 264 extends across appliance base 116 to basement 146.

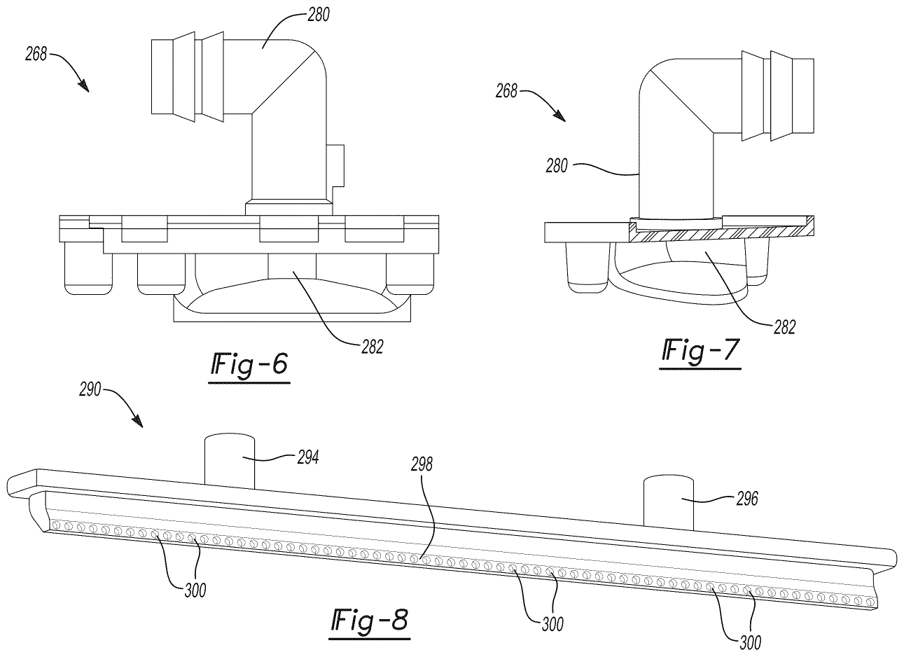

Conduit 264 is connected to a first nozzle 268 and a second nozzle 270 mounted to base cover 244 over second basement opening 158. As will be detailed more fully herein, first nozzle 268 and second nozzle 270 selectively deliver a jet or stream of fluid onto surfaces of filter 224 to remove any accumulated lint and/or debris (i.e., detritus). Reference will now follow to FIGS. 6 and 7, in describing first nozzle 268 with an understanding that second nozzle 270 may be similarly formed. First nozzle 268 includes a nozzle inlet 280 and a nozzle outlet 282 that creates a shaped stream of liquid directed onto an outer, upstream, surface (not separately labeled) of filter 224. In one example, the shaped stream takes the form of a fan shape that maximizes contact with filter 224 to remove debris more effectively and efficiently. The number and location of nozzles may vary depending on the appliance model and cleaning requirements.

A nozzle 290, in accordance with another aspect of the present disclosure, is shown in FIG. 8. Nozzle 290 includes a first nozzle inlet 294 and a second nozzle inlet 296. First nozzle inlet 294 and second nozzle inlet 296 are connected to conduit 264 and to a single nozzle outlet 298 having a plurality of openings 300. Single nozzle outlet 298 extends between first nozzle inlet 294 and second nozzle inlet 296 that releases a curtain of fluid that extends across substantially an entirety of filter 224. The wide outflow or curtain of liquid removes debris that may be trapped on the outer, upstream surface of filter 224.

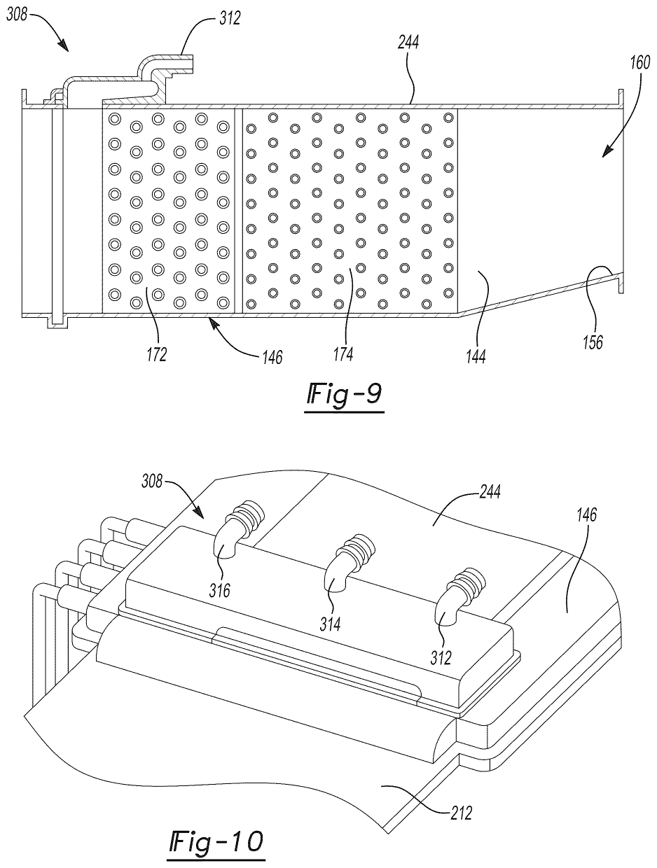

FIGS. 9 and 10 depict a nozzle 308 mounted to base cover 244 at second basement opening 158. In the non-limiting example shown, basement 146 does not include a filter. Nozzle 308 includes a first nozzle inlet 312, a second nozzle inlet 314, and a third nozzle inlet 316. Each of the first nozzle inlet 312, the second nozzle inlet 314, and the third nozzle inlet 316 are connected to conduit 264. Nozzle 308 also includes a nozzle outlet 320. Nozzle outlet 320 is directed inwardly to basement cavity 246 and configured to direct jets of fluid onto surfaces of first heat exchanger 172. Nozzle outlet 320 may also be configured to direct jets of fluid onto surfaces of second heat exchanger 174. As will be detailed more fully herein, nozzle 308 is selectively connected with the main water supply and or condensate holding tank 177 to direct streams and/or jets of fluid onto surfaces of first heat exchanger 172.

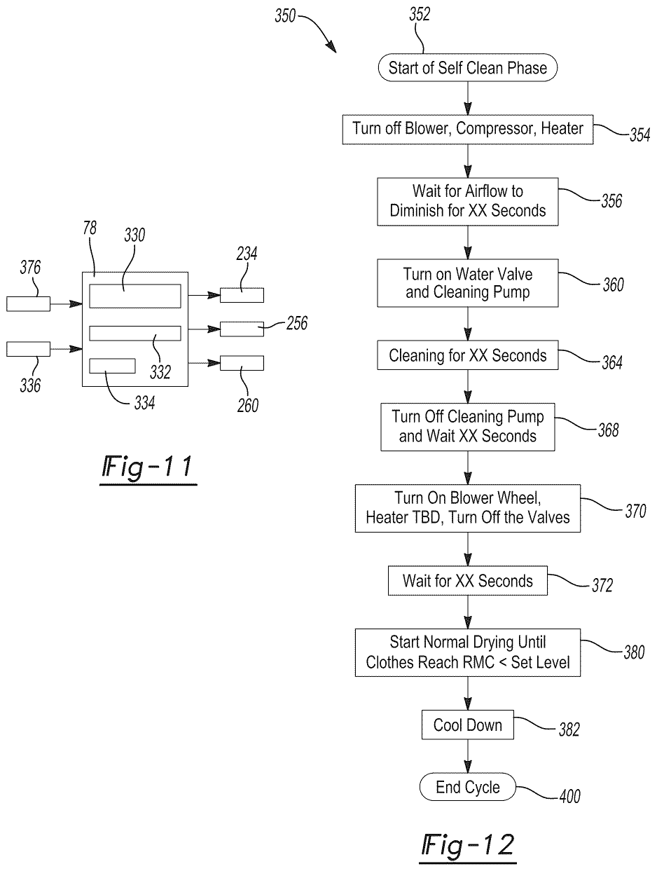

FIG. 11 depicts a control module 78 connected to motor 234, valve 256, and pump 260. In a non-limiting example, control module 78 includes a central processing unit (CPU) 330, a non-volatile memory module 332, and a pump control module 334. As will be detailed more fully herein, control module 78 selectively activates pump 260 to direct water through self-cleaning system 250 to clean surfaces of, for example, filter 224 and/or basement 146. Self-cleaning system 250 may be activated based on a number of factors including laundry parameters, such as motor torque, airflow pressure, or the like sensed by a sensor 336. Motor torque and/or an airflow pressure drop across filter 224 may be indicators that the basement surfaces and/or filter 224 would benefit from a cleaning.

Reference will now follow to FIG. 12 in describing a method 350 of activating self-cleaning system 250 in accordance with a non-limiting example. In block 352, the self-cleaning system 250 is activated. Self-cleaning system 250 may be activated based on sensed motor torque, at a set time of day, on a selected duty cycle, for example, every 4 uses of laundry appliance 50, and/or based on selected sensed motor torque, etc. Further, self-cleaning system 250 may be activated at the end of a drying cycle before a cool down phase, or at the end of the drying cycle after the cool down phase takes place.

In block 354, motor 234 is deactivated allowing blower 230 and drum 90 to come to rest. At the same time, a drain pump (not shown) may be activated to evacuate condensate holding tank 177. In block 356, control module 78 waits for the airflow from blower 230 to diminish for a selected period of time. In block 360, valve 256 is activated allowing water to pass to pump 260. Pump 260 is activated to direct water through conduit 264 to, for example, first nozzle 268 and second nozzle 270. The particular nozzle to which water is directed may vary depending on how laundry appliance 50 is configured.

In block 364, cleaning of filter 224 and/or surfaces of basement 146 continues for a selected period of time. At the end of the selected time period, which may be stored in non-volatile memory module 332, pump 260 is deactivated in block 368. After another selected period of time, in block 370, blower motor portion 238 of motor 234 may be activated to direct an airflow through basement 146 and valve 256 is turned off.

After operating blower 230 for a selected time period in block 372, laundry appliance 50 continues drying articles in drum 90 in block 380 until a selected remaining moisture content (RMC) is detected. The selected (RMC) may be detected by sampling air in return duct 240 at a sensor 376. Once the selected RMC is reached in laundry compartment 110, the drying cycle ends, a laundry compartment 110 is allowed to cool in block 382 for a selected time period, and the drying cycle ends in block 400.

At this point, it should be understood that the present disclosure describes a system for initiating a self-cleaning of internal surfaces of a heat pump dryer. By cleaning the internal surfaces without the need to disassemble the laundry appliance, airflow through the heat exchanger may be maximized and heat exchange efficiencies increased. Further, while shown as being connected to a main water supply, the self-cleaning system could, in the alternative, be supplied with cleaning fluid from the condensate collection tank. Additionally, it should be understood that the number and position of the nozzles may vary.

Example embodiments are provided so that this disclosure will be thorough and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

When the terms “about” or “substantially” are used in this specification in connection with a numerical value, it is intended that the associated numerical value includes a manufacturing or operational tolerance (e.g., ±10%) around the stated numerical value. Moreover, when the terms “generally” or “substantially” are used in connection with geometric shapes, it is intended that precision of the geometric shape is not required but that latitude for the shape is within the scope of the disclosure. Furthermore, regardless of whether numerical values or shapes are modified as “about,” “generally,” or “substantially,” it will be understood that these values and shapes should be construed as including a manufacturing or operational tolerance (e.g., ±10%) around the stated numerical values or shapes.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected, or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer, or section. Terms such as “first,” “second,” and other numerical terms when used herein do not imply a sequence or order unless clearly indicated by the context. Thus, a first element, component, region, layer, or section discussed below could be termed a second element, component, region, layer, or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below”, or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A laundry appliance comprising:
a cabinet;
a drum rotatably supported in the cabinet;
a blower fan arranged in the cabinet;
a basement arranged in the cabinet, the basement including a first basement opening, a second basement opening, and a basement cavity defined between the first basement opening and the second basement opening;
a connector channel connecting the first basement opening in fluid communication with the drum;
an airflow channel connecting the blower fan in fluid communication with the second basement opening;
a heat exchanger system arranged in the basement cavity and arranged in fluid communication with the airflow channel; and
a self-cleaning system including a nozzle directed at the second basement opening, the self-cleaning system selectively directing a jet of fluid onto the heat exchanger and/or basement surfaces to remove detritus.

2. The laundry appliance according to claim 1, further comprising a filter arranged at the second basement opening, the nozzle being configured to selectively direct the jet of fluid onto the filter.

3. The laundry appliance according to claim 1, wherein the nozzle is configured to direct the jet of fluid into the basement.

4. The laundry appliance according to claim 3, wherein the nozzle is configured to direct the jet of fluid onto the heat exchanger system.

5. The laundry appliance according to claim 3, wherein the heat exchanger system includes an evaporator having an evaporator coil and a condenser having a condenser coil, the nozzle being configured to direct the jet of fluid onto surfaces of one of the evaporator coil and the condenser coil.

6. The laundry appliance according to claim 1, further comprising a condensate holding tank arranged on the appliance base, the nozzle being connected in fluid communication with the condensate holding tank, wherein the fluid comprises condensate from the condensate holding tank.

7. The laundry appliance according to claim 1, further comprising a main water connection connected in fluid communication with the nozzle, wherein the fluid comprises water from a main water supply connected to the main water connection.

8. The laundry appliance according to claim 1, further comprising a controller operatively connected to the self-cleaning system, the controller selectively causing the fluid to be sprayed from the nozzle during a selected portion of a drying cycle.

9. The laundry appliance according to claim 8, wherein the controller causes the fluid to be sprayed from the nozzle at an end of the drying cycle.

10. The laundry appliance according to claim 8, further comprising a sensor arranged in fluid communication with the drum, the sensor being configured to detect a remaining moisture content (RMC) of articles of laundry in the drum and signal the controller to direct the fluid through the nozzle at a selected flow rate, volume, or time duration.

11. A method of cleaning a laundry appliance comprising:
loading articles to be dried into a drum;
activating a drum motor to rotate the drum;
directing a flow of air into the drum to dry the articles;
supplying an amount of fluid to a nozzle directed at a heat exchanger system and/or basement of the laundry appliance; and
spraying the fluid from the nozzle towards the heat exchanger system and/or the basement.

12. The method of claim 11, further comprising:
detecting that a dryer cycle has ended; and
pausing for a selected time period after the dryer cycle has ended before spraying the fluid from the nozzle.

13. The method of claim 11, further comprising:
detecting a remaining moisture content (RMC) of the articles in the drum; and
spraying the fluid from the nozzle towards the heat exchanger system and/or the basement when the RMC reaches a selected value.

14. The method of claim 11, further comprising:
detecting motor torque of the drum motor; and
spraying the fluid from the nozzle towards the heat exchanger system and/or the basement when the motor torque reaches a selected value.

15. The method of claim 11, wherein spraying the fluid from the nozzle includes directing the fluid from the nozzle based on a selected duty cycle.

16. The method of claim 11, wherein spraying the fluid from the nozzle includes directing the fluid towards a filter arranged across an opening formed in the basement.

17. The method according to claim 11, wherein spraying the fluid from the nozzle towards the heat exchanger system and/or the basement includes directing the fluid into a basement cavity of the basement.

18. The method according to claim 17, wherein directing the fluid toward the heat exchanger system includes directing the fluid onto a compressor coil and/or evaporator coil of the heat exchanger system.

19. The method according to claim 18, wherein directing the fluid towards the heat exchanger system includes cleaning surfaces of at least one of the evaporator coil and the condenser coil.

20. The method according to claim 11, wherein the step of supplying an amount of fluid to the nozzle includes one of opening a valve to supply an amount of water to flow from a main water supply to the nozzle or pumping an amount of condensate from a condensate holding tank to the nozzle.
